(19) United States
(12) Patent Application Publication
(10) Pub. No.: US 2026/0354414 A1
(43) Pub. Date: Nov. 12, 2026

(54) WHOLE BLOOD FEED COMPOSITION HYDROLYZED BY SERINE PROTEASE FOR INCREASING PRODUCTIVITY AND IMMUNITY OF WEANED PIGLET

(71) Applicant: AMINOLAB CO., LTD., Sejong-si (KR)

(72) Inventors: In Ho KIM, Sejong-si (KR); Jae Hong PARK, Cheonan-si (KR); Wha Jung CHO, Sejong-si (KR); Tae Heon HAN, Gwangmyeong-si (KR); Ki Woo KIM, Seoul (KR); Hae Sung PARK, Sejong-si (KR)

(21) Appl. No.: 19/344,243

(22) Filed: Sep. 29, 2025

(30) Foreign Application Priority Data
May 8, 2025 (KR) 10-2025-0059512

(51) Int. Cl. A23K 10/24; A23K 10/14; A23K 20/142; A23K 50/30; A23K 50/60

(52) U.S. Cl. CPC A23K 10/24; A23K 10/14; A23K 20/142; A23K 50/30; A23K 50/60; C12Y 304/21

(57) ABSTRACT

The present disclosure relates to application of a feed composition composed of slaughter blood hydrolysate, which exerts the effect of increasing the productivity and immunity of a weaned piglet.

### CROSS-REFERENCE TO RELATED APPLICATIONS

This application claims the priority of the Korean Patent Applications No. 10-2025-0059512, filed on May 8, 2025, in the Korean Intellectual Property Office. The entire disclosures of all these applications are hereby incorporated by reference.

### TECHNICAL FIELD

The present disclosure relates to the use of a slaughter blood hydrolysate as a feed composition having the effect of increasing the productivity and immunity of a weaned piglet.

### BACKGROUND

In recent years, about 90 slaughterhouses are operated to slaughter edible livestock in Korea. In these slaughterhouses, more than 80,000 tons of blood are discharged annually. Only about 10% of slaughter blood is being recycled worldwide, and most of the slaughter blood are being disused. In the case of the pig, the slaughter blood is about 2.5 to 3.0 liter (L) per animal. The annual slaughter blood of pigs is about 39,216 tons, which has a great impact on water pollution. Blood, which accounts for about 7% of the total weight, contains 75 to 80% of water and 15 to 7% of high-quality protein. The protein is composed of albumin, globulin, and hemoglobin. The slaughter blood contains a large amount of useful ingredients and therefore has a high level of potential commercial value. However, there is a lack of research on the industrial use of blood. As a result, most of the blood is being discarded. Immune proteins and various peptide groups that exist in the blood of the livestock are newly emerging bioactive substances in the protein material market over the past few years, and have excellent amino acid composition. Thus, the immune proteins and the peptide groups have proven to be of excellent nutritional values. In addition, the peptide groups of hemoglobin that present in the blood exhibits antibacterial effects according to hydrolytic enzyme properties so that they may be used as a natural preservative in the storage and sale of meat-based products.

On the other hand, proteases have various functions such as digestion, absorption, and defense in vivo, and are classified into a serine protease, a cysteine protease, an aspartate protease, and a metalloprotease depending on a structure of an active site. Among them, the serine protease (or serine endopeptidase) has commonly an active serine residue mainly at the active site, and is an enzyme that acts as a nucleophilic amino acid at the active site of the serine protease to cleave peptide bonds in the protein (see Hedstrom, 2002. Chem Rev 102:4501-4524).

Meanwhile, this application is sponsored by the national research and development project described below.
Project identification number: 2340001412
Project number: 00275307
Ministry: Ministry of Education
Project management (specialized) organization: National Research Foundation of Korea
Research business name: Establishment of a research base for science and engineering
Research project name: Smart Animal Bio Research Institute
Project performing organization: Dankook University Cheonan Campus Industry-Academic Cooperation Foundation
Research period: Mar. 1, 2024-Feb. 28, 2025

### SUMMARY

The present disclosure was made to solve the above-mentioned matters, and the present disclosure is for the purpose of providing a feed additive containing a slaughter blood hydrolysate as an active ingredient.

Further, the present disclosure is for the purpose of providing a feed composition containing a slaughter blood hydrolysate.

Further, the present disclosure is for the purpose of providing a method of producing a slaughter blood hydrolysate.

The technical matters to be achieved in the present disclosure are not limited to the technical problems described above, and other technical problems not mentioned will be clearly understood by those skilled in the art from the following description.

In order to solve the aforementioned matters, the present disclosure provides a feed additive containing a slaughter blood hydrolyzate as an active ingredient.

Further, the present disclosure provides a feed composition containing the aforementioned feed additive.

Further, the present disclosure provides a method of producing the slaughter blood hydrolysate including an operation of grinding a slaughter blood collected at a slaughterhouse, an operation of performing a hydrolyzation, an operation of performing a heating at 80 to 95 °C, and an operation of performing a drying.

As described above, according to 'a slaughter blood hydrolyzate of the present disclosure, it is possible to solve matters such as a reduction in digestibility and a loss of amino acid of a blood meal in the related art.

Further, according to the slaughter blood hydrolysate of the present disclosure, the amino acid may be effectively pre-decomposed to produce functional peptides, which makes it possible to improve the digestibility of the amino acid and the immunity.

Further, the slaughter blood hydrolysate of the present disclosure includes the amino acid in a relatively balanced manner compared to a blood meal in the related art, and is rich in essential amino acid.

Further, the slaughter blood hydrolysate of the present disclosure has a higher water solubility than that of the blood meal in the related art. Thus, the slaughter blood hydrolysate of the present disclosure may be used effectively as a liquid feed or feed additive. Further, it is possible to provide an improvement in digestibility and an enhancement in nutritional property.

Further, according to the slaughter blood hydrolysate of the present disclosure, an unpleasant odor may be reduced during the hydrolyzation, thereby enhancing palatability.

Further, unlike a method of producing a blood meal in the related art, a method of producing the slaughter blood hydrolysate of the present disclosure includes causing a reaction without adjustment of pH while bypassing an operation of removing insoluble substances. Thus, only blood components may be included in the produced slaughter blood hydrolysate. Further, phospholipids and minerals may be included in the produced slaughter blood hydrolysate.

Further, according to the method of producing the slaughter blood hydrolysate of the present disclosure, it is possible to significantly reduce an amount of wastewater and waste product compared to a blood meal production method in the related art.

### DETAILED DESCRIPTION

This application was proposed through “Agriculture New Technology Industry-Academia Cooperation Support Project” of Korea Agriculture Technology Promotion Agency.

Hereinafter, preferred embodiments of the present disclosure will be described in detail with reference to the accompanying drawings. Advantages and features of the present disclosure, and a method of achieving them, will become more apparent by example embodiments described below in detail in conjunction with the accompanying drawings. However, the present disclosure is not limited to example embodiments which will be described later, and may be implemented in various different forms. The present example embodiments merely completely describe the present disclosure, and are provided to faithfully explain the scope of the present disclosure to those skill in the art to which the present disclosure pertains. The present disclosure is merely defined by the scope of the claims. Throughout this specification, like reference numerals refer to like constituent elements.

Unless otherwise defined, all terms (such as technical and scientific terms) used herein have the same meaning commonly understood by those skilled in the art to which the present disclosure pertains. In addition, the commonly-used predefined terms should not be interpreted as having ideal or excessive meanings unless otherwise defined in this application. Terms used herein is for the purpose of describing example embodiments and is not intended to limit the present disclosure. The singular form described herein may include the plural form unless the context clearly dictates otherwise.

Further, the expression “comprises” and/or “comprising” used herein are intended to include constituent elements, processes, operations and/or elements, but may be constructed not to exclude one or more other constituent elements, processes, operations and elements in addition to the above-described terms.

Throughout this specification, the term “%” used to indicate a concentration of a particular substance refers to % by weight (w/w) unless otherwise stated.

The term “feed” used herein refers to a material (materials) consumed by an animal and providing energy and/or nutrients to an animal's diet. Examples of the feed may include Total Mixed Rations (TMR), forage(s), pellet(s), concentrate(s), premix(s), by-product(s), grain(s), distiller grain(s), molasses, fiber(s), fodder(s), grass(s), hay, kernel(s), leaves, meal, soluble substance(s), and supplement(s), but not limited thereto.

The term “feed composition” used herein refers to a feed provided to a livestock. The feed composition refers to a substance that supplies organic or inorganic nutrients necessary for supporting the life of the livestock or producing meat, milk, or the like. The feed composition may further include additional nutrients necessary for supporting the life of livestock or producing meat, milk, or the like.

The term “w/w (weight/weight)” used herein refers to an amount of a predetermined substance in a composition in terms of weight.

In one aspect, there is provided a feed additive containing a slaughter blood hydrolyzate as an active ingredient.

In one implementation, the slaughter blood hydrolyzate may be a hydrolyzed blood meal obtained by hydrolyzing a slaughter blood with a serine protease.

In one implementation, the slaughter blood hydrolyzate may be a hydrolyzed blood meal produced by grinding slaughter blood clots with a blood liquefaction machine, hydrolyzing the ground slaughter blood clots with the serine protease, and drying the same.

In one implementation, the hydrolyzed blood meal may include 80 to 90% by weight of crude protein, 0.5 to 0.9% by weight of crude fat, and 0.5 to 1.0% by weight of crude fiber with reference to 100% by weight of the hydrolyzed blood meal.

In one implementation, a pepsin digestibility of the hydrolyzed blood meal may be 90% or more, specifically 90 to 100% by weight.

In another aspect, there is provided a feed composition including the aforementioned feed additive.

In one implementation, the feed composition may include 3 to 10% by weight of the feed additive, specifically 4 to 8% by weight, with reference to 100% by weight of the feed composition.

In one implementation, the feed composition may be a feed composition for livestock or aquacultured fish.

In one implementation, examples of the livestock may include cattle, pig, goat, sheep, horse, chicken, duck, turkey, and the like, specifically the pig, more specifically a weaned piglet.

In one implementation, the feed composition may be formulated in the form of a general feed and may further include general feed ingredients.

In one implementation, the feed composition may be used to increase the productivity of young livestock, specifically the weaned piglet, and may be used to increase a body weight or daily weight gain of the weaned piglet.

In one implementation, the feed composition may be used to enhance the immunity of the young livestock, specifically the weaned piglet. By adding the feed additive, it is possible to reduce levels of IL-6 or TNF-α or increase a level of CD4 or CD8 in the weaned piglet at the time of occurrence of inflammation.

In one implementation, the feed composition may include the feed additive to improve the digestibility of nutrients of the young livestock, specifically the weaned piglet, and may improve the digestibility of essential or nonessential amino acid.

In one implementation, the feed composition may include the feed additive to increase the digestibility of threonine, leucine, histidine, lysine, methionine, serine, pro line, glycine, tyrosine, or cystine in the young livestock, particularly the weaned piglet.

In one embodiment, the feed composition may include general basal diets to be provided to various livestock species. Ingredients, compositions, and suitable composition ratios of the basal diets, which are necessary for the livestock species, are all well-known in the art, and are commercially available. Thus, a person skilled in the art may easily produce, purchase or utilize the basal diets. Specifically, the basal diet may include some or all of a starch-containing substance, a protein-containing substance, a fat-containing substance, a vitamin-containing substance, an inorganic matter-containing substance, an antioxidant substance, an antibiotic, and the like according to the livestock species. The starch-containing substance may be included in the basal diet for livestock as long as it may support the growth of the livestock. The starch-containing substance is generally obtained from a corn, soybean, wheat, sorghum, barley, oat, or the like. In general, the starch-containing substance may be included in the basal diet in a range of about 30 to 80% by weight with reference to the total weight of the feed composition. The protein-containing substance may also be included in the basal diet for livestock as long as it may support the growth of the livestock. From an economic point of view, protein-containing substances such as fish meal and soybean powder may be used. The protein-containing substance may be included in the basal diet in a range of about 10 to 50% by weight with reference to the total weight of the composition. The fat-containing substance may include a lard, beef tallow, soybean oil, lecithin, coconut oil, or the like, but not limited thereto. In general, the lard-containing substance may be included in the basal diet in a range of about 2 to 20% by weight with reference to the total weight of the composition. Further, the basal diet may include water-soluble and fat-soluble vitamins, and a trace amount of minerals. Examples of the vitamin may include vitamin A, vitamin D, vitamin E, vitamin K, riboflavin, pantothenic acid, niacin, vitamin B12, folic acid, biotin, vitamin C, and the like. Examples of the trace amount of minerals may include a copper, zinc, iodine, selenium, manganese, iron, cobalt and the like. The expression “the trace amount” used here means that the amount of these ingredients used in the basal diet for livestock is substantially less than the amounts of other ingredients. Generally, when the trace amount of vitamins or minerals are included in the basal diet, the trace amount may be in a range of about 0.0001 to 5% by weight with reference to the total weight of the composition.

In one aspect, the present disclosure provides a method of producing a slaughter blood hydrolyzate, which includes: grinding a slaughter blood collected at a slaughterhouse; performing a hydrolyzation; performing a heating at 80 to 950 °C; and performing a drying.

In one implementation, the slaughter blood may be a clotted blood, and the clotted blood may be ground by a blood liquefaction machine during the grinding.

In one implementation, the hydrolyzation is performed by treating the ground slaughter blood with a serine protease. The serine protease may be a serine endopeptidase.

Hereinafter, specific example embodiments of the present disclosure will be described.

### Example 1: Production of Serine Protease-Hydrolyzed Blood Meal

Clotted blood collected at the slaughterhouse was cooled and then ground using a blood liquefaction machine. The blood was treated with serine endopeptidase, hydrolyzed at 50 to 60 °C for 3 hours or more, and then heated at 85 °C for 30 minutes or more to inactivate microorganisms and enzymes. Thereafter, the blood was dried using a spray dryer (inlet: 180 to 200 °C and outlet: 80 to 100 °C) to produce a hydrolyzed blood meal. Ingredients of the hydrolyzed blood meal were analyzed (see Table 1).

TABLE 1

| General | Moisture | 4.55 | | Fatty acid | C16:0 | 23.35% |
|---|---|---|---|---|---|---|
| Ingredients | Crude | 89.96 | | (in Total | C18:0 | 20.74% |
| (in Total | Protein | | | 0.74%) | | |
| 100%) | Crude | 0.74 | | | C18:1n9 | 37.10% |
| | Fiber | | | | | |
| | Crude fat | 0.80 | | | C18:2n6 | 11.28% |
| | Cruciate | 4.80 | | Heavy Metal | Lead | Not |
| | sulcus | | | | | Detected |
| | Pepsin | 96.47% (0.2% | | | Cadmium | Not |
| | Digest- | Pepsin) | | | | Detected |
| | ibility | 98.01% (0.0002% | | | | |
| | | Pepsin) | | | | |
| Inorganic | Calcium | 0.05% | | | Arsenic | Not |
| substance | | | | | | Detected |
| | Kalium | 1.05% | | | Mercury | Not |
| | | | | | | Detected |
| | Magnesium | 0.03% | | | Chromium | Not |
| | | | | | | Detected |
| | | | | | Fluorine | Not |
| | | | | | | Detected |
| | Sulfur | 0.70% | | Harmful | Coliform | N.C |
| | | | | microorganism | | (10\hat{ }1) |
| | Iron | 3,038 | ppm | | Fungal | N.C |
| | | | | | count | (10\hat{ }1) |
| | Zinc | 18 | ppm | | Salmonella | Not |
| | | | | | | Detected |

### Example 2: Production of Feed Composition Containing Serine Protease-Hydrolyzed Blood Meal

In order to confirm the effect of the blood meal (enzymatic hydrolyzed whole blood) obtained by hydrolyzing the slaughter blood in Example 1 above, which is used as feed additives, a test feed (TRT2) was produced by adding 6% by weight of the blood meal to a corn-soybean oil meal-based feed (CON) which is formulated according to requirements of National Research Council (NRC) (2012) (see Table 2). In this, case, a test feed (TRT1) containing 6% by weight of a commercial blood meal (blood plasma protein) was also produced for comparison.

TABLE 2

Dietary treatment

| | | | |
|---|---|---|---|
| Item | CON | TRT1 | TRT2 |

Ingredients (%)

| | | | |
|---|---|---|---|
| Corn | 37.22 | 42.39 | 38.41 |
| Soybean meal | 23.02 | 16.00 | 14.82 |
| Fermented Soybean meal | 8.00 | 5.00 | 5.00 |
| Blood plasma protein | — | 6.00 | — |
| Enzymatic hydrolyzed | — | — | 6.00 |
| whole blood | | | |
| Soybean oil | 3.43 | 2.76 | 7.70 |
| Lactose | 14.56 | 14.19 | 14.19 |
| Whey protein | 10.00 | 10.00 | 10.00 |
| Mono-dicalcium | 1.23 | 1.12 | 1.60 |
| phosphate | | | |
| Limestone | 0.83 | 0.95 | 0.68 |
| Salt | 0.20 | 0.20 | 0.20 |
| Methionine (99%) | 0.21 | 0.23 | 0.25 |
| Lysine (78%) | 0.62 | 0.48 | 0.47 |
| Mineral mix² | 0.20 | 0.20 | 0.20 |
| Vitamin mix³ | 0.20 | 0.20 | 0.20 |
| ZnO (80%) | 0.25 | 0.25 | 0.25 |
| Choline (25%) | 0.03 | 0.03 | 0.03 |
| Total | 100.00 | 100.00 | 100.00 |

Calculated value

| | | | |
|---|---|---|---|
| Crude protein, % | 20.00 | 20.00 | 20.00 |
| ME (kcal/kg) | 3450 | 3450 | 3450 |
| Ca, % | 0.80 | 0.80 | 0.80 |
| P, % | 0.60 | 0.60 | 0.60 |
| Lys, % | 1.60 | 1.60 | 1.60 |
| Met, % | 0.48 | 0.48 | 0.48 |

Analyzed value

| | | | |
|---|---|---|---|
| Crude protein, % | 20.09 | 19.80 | 20.00 |
| Ca, % | 0.85 | 0.83 | 0.90 |
| P, % | 0.70 | 0.53 | 0.58 |
| Lys, % | 1.58 | 1.68 | 1.72 |
| Met, % | 0.56 | 0.49 | 0.41 |
| Thr, % | 1.13 | 1.22 | 1.30 |
| Trp, % | 0.34 | 0.39 | 0.34 |

¹Abbreviation, CON, basal diet; TRT1, Basal diet soybean meal replaced with 6.0% blood plasma protein; TRT2, basal diet soybean meal replaced with 6.0% enzymatic hydrolyzed whole blood.
²Provided per kg diet: Fe, 100 mg as ferrous sulfate; Cu, 17 mg as copper sulfate; Mn, 17 mg as manganese oxide; Zn, 100 mg as zinc oxide; I, 0.5 mg as potassium iodide; and Se, 0.3 mg as sodium selenite.
³Provided per kilograms of diet: vitamin A, 10,800 IU; vitamin D3, 4,000 IU; vitamin E, 40 IU; vitamin K3, 4 mg; vitamin B1, 6 mg; vitamin B2, 12 mg; vitamin B6, 6 mg; vitamin B12, 0.05 mg; biotin, 0.2 mg; folic acid, 2 mg; niacin, 50 mg; D-calcium pantothenate, 25 mg;

### Example 3: Analysis of Productivity of Feed Composition Containing Serine Protease-Hydrolyzed Blood Meal

The test feeds such as CON (basal diet), TRT1 (basal diet+6% by weight of the commercial blood meal), and TRT2 (basal diet+6% by weight of the serine protease-hydrolyzed blood meal) which are produced in Example 2 above, were randomly provided to 150 weaned piglets of a three-way crossbreed [(Landrace×Yorkshire)×Duroc] having an initial body weight of 6.53±1.27 kilogram (kg) through three treatments. Each treatment was repeatedly performed 10 times. In each repetitive treatment, the 150 weaned piglets were perfectly randomly sorted into groups of 5 weaned piglets. Water was automatically provided using an automatic waterer. In order to confirm a growth performance of the weaned piglet, the body weight of each weaned piglet was measured at the initial stage, 1 week, 3 weeks, and the end stage (6 weeks). A feed intake was calculated by subtracting a remaining amount from an amount of the feed provided at the time of measuring the body weight. A feed demand rate was calculated by dividing the feed intake by daily weight gain.

TABLE 3

| | | | | |
|---|---|---|---|---|
| Items | CON1 | TRT1 | TRT2 | SEM² |

Body weight, kg

| | | | | |
|---|---|---|---|---|
| Initial | 6.54 | 6.53 | 6.53 | 0.01 |
| Week 1 | 8.67 | 8.74 | 8.78 | 0.04 |
| Week 3 | 14.58^{b} | 14.82^{b} | 15.04^{a} | 0.11 |
| Week 6 | 24.94^{b} | 25.67^{ab} | 26.25^{a} | 0.26 |

Initial-Week 1

| | | | | |
|---|---|---|---|---|
| ADG, g | 305 | 315 | 321 | 6 |
| ADFl, g | 388 | 398 | 403 | 7 |
| FCR | 1.273 | 1.264 | 1.255 | 0.006 |

Week 1-Week 3

| | | | | |
|---|---|---|---|---|
| ADG, g | 422^{b} | 434^{ab} | 447^{a} | 8 |
| ADFl, g | 607 | 617 | 631 | 10 |
| FCR | 1.437 | 1.422 | 1.412 | 0.011 |

Week 3-Week 6

| | | | | |
|---|---|---|---|---|
| ADG, g | 493^{b} | 516^{ab} | 534^{a} | 11 |
| ADFl, g | 805 | 824 | 847 | 18 |
| FCR | 1.634 | 1.597 | 1.588 | 0.018 |

Overall

| | | | | |
|---|---|---|---|---|
| ADG, g | 438^{b} | 455^{ab} | 469^{a} | 6 |
| ADFl, g | 669 | 684 | 701 | 10 |
| FCR | 1.528 | 1.502 | 1.494 | 0.011 |

¹Abbreviations, CON, basal diet; TRT1, basal diet + 6% blood meal; TRT2, basal diet + 6% enzymatic hydrolyzed meal.
²Standard error of means.
^{a, b}Means in the same row with different superscripts differ significantly (P < 0.05).

As a result, at the third week of the test, the body weight and the daily weight gain of the serine protease-hydrolyzed blood meal group (TRT2) was significantly higher than those of the normal blood meal group (TRT1) and the control group (CON) (see Table 3). Further, at the sixth week of the test, in addition to the body weight and the daily weight gain, the daily weight gain of the serine protease-hydrolyzed blood meal group (TRT2) throughout the test was also significantly higher than those of the normal blood meal group (TRT1) and the control group (CON) (see Table 3).

It was found from the above results that, by hydrolyzing the blood meal, which has a very high protein content of 80% or more and is rich in essential amino acids such as lysine and leucine essential for the growth of the piglet, it is possible to maximize a utilization efficiency and absorption rate of the protein, thereby promoting the weight gain.

### Example 4: Analysis of Nutrient Digestibility of Feed Composition Containing Serine Protease-Hydrolyzed Blood Meal

In order to confirm a change in nutrient digestibility of the feed composition due to the addition of the serine protease-hydrolyzed blood meal, 0.5% of chromium oxide (Cr203) was added as a marker to each test feed. The test feed was provided for 4 days prior to the end of the test. Thereafter, an ileal digesta was collected for 2 days using a T-cannula. The collected ileal digesta was dried using a freeze dryer kept at −80 °C for 72 hours. Thereafter, the dried ileal digesta was ground and analyzed in terms of Cr and nutrients using a method proposed in Association of Official Analytical Chemists (AOAC) (2000). The ileal digesta was acid-hydrolyzed with 6N-HCl at 100 °C for 24 hours and then measured using an amino acid analyzer (manufactured by Sykam GmbH, Furstenfeldbruck located in Germany). Thereafter, an amino acid composition was analyzed by evaporation at 500 °C using an evaporator (manufactured by HAHNSHIN S&T Co. Ltd. located in Gyungi-do, Korea). A sample was oxidized by a sulfur-containing amino acid as a performic acid and a change due to such an oxidization was analyzed. Further, an ileal digestibility based on the amino acid was calculated according to a method proposed by Stein et al. (2007).

TABLE 4

| | | | | | |
|---|---|---|---|---|---|
| Items | CON | TRT1 | TRT2 | SEM² | P-valve |

Apparent Ileal Digestibility

| | | | | | |
|---|---|---|---|---|---|
| Dry matter, % | 72.96 | 73.38 | 73.79 | 0.32 | 0.112 |
| Nitrogen, % | 72.72 | 73.40 | 74.20 | 0.43 | 0.051 |
| Energy, % | 73.11 | 73.20 | 74.07 | 0.40 | 0.141 |

Essential amino acid

| | | | | | |
|---|---|---|---|---|---|
| Threonine | 73.40^{b} | 77.99^{ab} | 81.77^{a} | 1.58 | 0.009 |
| Valine | 71.83 | 73.93 | 76.86 | 3.12 | 0.297 |
| Isoleucine | 87.47 | 89.44 | 898.51 | 0.88 | 0.154 |
| Leucine | 64.82^{b} | 71.72^{ab} | 77.49^{a} | 2.53 | 0.012 |
| Phenylalanine | 63.32 | 65.85 | 67.25 | 1.98 | 0.201 |
| Histidine | 93.83^{b} | 95.31^{a} | 96.42^{a} | 0.42 | 0.004 |
| Lysine | 58.56^{c} | 61.27^{b} | 63.60^{a} | 0.40 | <0.001 |
| Arginine | 51.76 | 58.05 | 63.52 | 4.00 | 0.082 |
| Methionine | 75.31^{c} | 78.43^{b} | 81.44^{a} | 0.64 | <0.001 |
| TEAA | 71.14^{b} | 74.66^{ab} | 77.55^{a} | 1.57 | 0.027 |

Non-Essential amino acid

| | | | | | |
|---|---|---|---|---|---|
| Aspartic acid | 74.36 | 77.00 | 80.20 | 2.30 | 0.122 |
| Serine | 70.82^{b} | 77.56^{a} | 82.08^{a} | 1.64 | 0.003 |
| Glutamic acid | 52.58 | 58.80 | 63.27 | 4.01 | 0.108 |
| Proline | 71.42^{b} | 78.60^{a} | 82.39^{a} | 1.36 | 0.001 |
| Glycine | 93.37^{b} | 94.22^{ab} | 94.87^{a} | 0.39 | 0.035 |
| Alanine | 80.56 | 82.94 | 85.69 | 1.66 | 0.071 |
| Tyrosine | 71.92^{b} | 80.05^{a} | 85.15^{a} | 1.87 | 0.002 |
| Cystine | 93.70^{b} | 92.96^{b} | 96.21^{a} | 0.37 | 0.002 |
| TNEAA | 76.09^{b} | 80.27^{ab} | 83.73^{a} | 1.65 | 0.016 |
| Total Amnio | 73.47^{b} | 77.30^{ab} | 80.46^{a} | 1.59 | 0.021 |
| Acid | | | | | |

¹Abbreviations, CON, basal diet; TRT1, basal diet + 6% blood meal; TRT2, basal diet + 6% enzymatic hydrolyzed meal.
²Standard error of means.
^{a, b}Means in the same row with different superscript differ significantly (P < 0.05).

As a result, it was found that, in terms of the digestibility of the essential amino acid, the digestibility of threonine, leucine, histidine, lysine and methionine in the serine protease-hydrolyzed blood meal group (TRT2), particularly the digestibility of the lysine and the methionine, are significantly higher than those in the normal blood meal group (TRT1) and the control group (CON) (see Table 4). Further, it was found that, in terms of the digestibility of the nonessential amino acid, the digestibility of serine, pro line, glycine, tyrosine and cystine in the serine protease-hydrolyzed blood meal group (TRT2), particularly the digestibility of the cystine, are significantly higher than those in the normal blood meal group (TRT1) and the control group (CON) (see Table 4).

Therefore, it was found that the protein of the blood meal was pre-decomposed through the protease treatment, which prompts the action of digestive enzymes in the body, increases the absorption rate and the utilization efficiency of the protein.

### Example 5: Analysis of Immune Response of Feed Composition Containing Serine Protease-Hydrolyzed Blood Meal

In order to confirm the influence of the addition of the serine protease-hydrolyzed blood meal on the inflammatory response of the weaned piglet, 20 weaned piglets (having the body weight of 15.34±1.17 kg) of the three-way cross breed [(Landrace×Yorkshire)×Duroc] were sorted into groups of CON1 (6% by weight of the commercial blood meal+Saline), CON2 (6% by weight of the commercial blood meal+LPS 100 microgram (μg)/kg), TRT1 (6% by weight of the serine protease-hydrolyzed blood meal+Saline), and TRT2 (6% by weight of the serine protease-hydrolyzed blood meal+LPS 100 μg/kg), and were subjected to four treatments 2 weeks. In each treatment, 5 weaned piglets were subjected to a specification experiment for two weeks. At the time of two weeks after the start of the experiment, the body weight of each weaned piglet was measured. Each weaned piglet was vaccinated with LPS at a concentration of 100 μg/kg. 2 mL of blood was collected from the jugular vein using a K3EDTA vacuum tube (manufactured by Becton Dickinson Vacutainer Systems located in Franklin Lakes, NJ) before the vaccination, and 6 hours and 12 hours after the vaccination. Analysis of a blood cell was performed by examining WBC and lymphocytes using an automated blood cell analyzer (manufactured by ADVIA 120, Bayer in USA). In addition, 5 mL of blood was collected using the vacuum tube (manufactured by Becton Dickinson Vacutainer Systems located in Franklin Lakes, NJ) and centrifuged at 3,000 revolutions per minute (rpm) for 15 minutes to obtain a blood plasma. TNF-α and IL-6 in the blood plasma were measured using an ELISA kit. Red cells were removed from blood collected for flow cytometry using a red cell solution buffer solution and then incubated for 30 minutes. The cells were washed with PBS containing 0.5% of albumin, dyed with 5 μL anti-porcine CD4 (produced by Southern Biotech, Birmingham located in AL, USA) and 5 μL anti-porcine CD8 (produced by Southern Biotech, Birmingham located in AL, USA), respectively. CD4 and CD8 were analyzed using a FACSCanto II flow cytometer (manufactured by BD Bioscience in USA).

TABLE 5

| | | | | | |
|---|---|---|---|---|---|
| Items | CON1 | CON2 | TRT1 | TRT2 | SEM² |

Initial

| | | | | | |
|---|---|---|---|---|---|
| IL-6, pg/mL | 91.22 | 89.46 | 84.09 | 85.50 | 3.89 |
| TNF-α, pg/mL | 113.59 | 116.89 | 109.98 | 107.91 | 4.06 |
| WBC, 10³/μl | 17.09 | 17.11 | 18.24 | 18.19 | 0.91 |
| Lymphocyte, % | 57.20 | 56.94 | 57.34 | 57.08 | 3.51 |
| CD4, % | 13.6 | 14.6 | 15.0 | 14.0 | 1.2 |
| CD8, % | 19.0 | 19.2 | 19.6 | 18.6 | 1.1 |

6 hours

| | | | | | |
|---|---|---|---|---|---|
| IL-6, pg/mL | 107.22^{c} | 801.73^{a} | 110.09^{c} | 742.25^{b} | 11.01 |
| TNF-α, pg/mL | 166.17^{c} | 1045.63^{a} | 171.29^{c} | 973.85^{b} | 14.39 |
| WBC, 10³/μl | 11.96^{b} | 16.96^{a} | 13.60^{b} | 18.08^{a} | 1.08 |
| Lymphocyte, % | 57.46^{b} | 71.88^{a} | 57.22^{b} | 72.14^{a} | 2.42 |
| CD4, % | 14.2^{c} | 21.0^{b} | 14.4^{c} | 25.2^{a} | 1.0 |
| CD8, % | 18.0^{c} | 39.6^{b} | 18.6^{c} | 43.8^{a} | 1.3 |

12 hours

| | | | | | |
|---|---|---|---|---|---|
| IL-6, pg/mL | 109.22^{b} | 432.73^{a} | 95.09^{b} | 398.75^{a} | 11.04 |
| TNF-α, pg/mL | 145.88^{c} | 736.83^{a} | 114.35^{c} | 674.89^{b} | 19.72 |
| WBC, 10³/μl | 15.16^{b} | 17.00^{ab} | 16.28^{ab} | 18.02^{a} | 0.65 |
| Lymphocyte, % | 56.96^{b} | 73.32^{a} | 57.22^{b} | 73.42^{a} | 3.28 |
| CD4, % | 14.8 | 14.6 | 15.6 | 15.8 | 1.1 |
| CD8, % | 18.6 | 18.4 | 20.0 | 20.2 | 1.1 |

¹Abbreviation: CON1, 6% blood meal + Saline; CON2, 6% blood meal + LPS 100 μg/kg; TRT1, 6% enzymatic hydrolyzed meal + Saline; TRT2, 6% enzymatic hydrolyzed meal + LPS 100 μg/kg.
²Standard error of means.
^{a, b, c}Means in the same row with different superscripts differ significantly (P < 0.05).

As a result, it was found that levels of IL-6 and TNF-α are increased rapidly by LPS challenge (6h). The levels of IL-6 and TNF-α in the serine protease-hydrolyzed blood meal group (TRT2) was increased compared to those in the commercially-available blood meal group (CON2) (see Table 5). This shows that the inflammatory response is not excessively prolonged, but rather regulated at an appropriate time point, and that the immune system is operated normally. Further, it was found that levels of CD4 and CD8 are increased rapidly by the LPS challenge (6h). That is, the levels of CD4 and CD8 in the serine protease-hydrolyzed blood meal group (TRT2) was significantly increased compared to those in the commercially-available blood meal group (CON2) (see Table 5). This shows that the immune system is further activated.

While example embodiments of the present disclosure have been described above with reference to the accompanying drawings, it will be understood by those skilled in the art that variations are readily possible in other specific forms without changing the technical ideas or essential features of the present disclosure. Therefore, it should be noted that the example embodiments described above are exemplary in all respects and are not restrictive.

What is claimed is:

1. A feed additive comprising:
a slaughter blood hydrolyzate as an active ingredient.

2. The feed additive of claim 1, wherein the slaughter blood hydrolyzate is a hydrolyzed blood meal obtained by hydrolyzing a slaughter blood with a serine protease.

3. The feed additive of claim 2, wherein the hydrolyzed blood meal includes 80 to 90% by weight of crude protein, 0.5 to 0.9% by weight of crude fat, and 0.5 to 1.0% by weight of crude fiber with reference to 100% by weight of the hydrolyzed blood meal.

4. The feed additive of claim 2, wherein a pepsin digestibility of the hydrolyzed blood meal is 90% or more.

5. A feed composition including the feed additive of claim 1.

6. The feed composition of claim 5, wherein the feed composition includes 3 to 10% by weight of the feed additive with reference to 100% by weight of the feed composition.

7. The feed composition of claim 5, wherein the feed composition is used to increase productivity.

8. The feed composition of claim 5, wherein the feed composition is used to enhance immunity.

9. A method of producing a slaughter blood hydrolyzate, the method comprising:
1) grinding a slaughter blood collected at a slaughterhouse;
2) performing a hydrolyzation;
3) performing a heating at 80 to 950 °C; and
4) performing a drying.

10. The method of claim 9, wherein the hydrolyzation is performed by treating a serine protease.
